(19) United States
(12) Patent Application Publication
(10) Pub. No.: US 2026/0303992 A1
(43) Pub. Date: Oct. 1, 2026

(54) ROW DRIVER ASSEMBLY AND SOLID-STATE IMAGING DEVICE

(71) Applicant: Sony Semiconductor Solutions Corporation, Kanagawa (JP)

(72) Inventors: Jae-Sung AN, Oslo (NO); Naoki KAWAZU, Kanagawa (JP)

(73) Assignee: Sony Semiconductor Solutions Corporation, Kanagawa (JP)

(21) Appl. No.: 19/164,243

(22) PCT Filed: Mar. 7, 2024
(86) PCT No.: PCT/EP2024/055944

§ 371 Date: Sep. 11, 2025

(30) Foreign Application Priority Data
Mar. 24, 2023 (EP) 23164052.5

(51) Int. Cl. H04N 25/709; G05F 1/46; H02M 3/07; H04N 25/779; H04N 25/79

(52) U.S. Cl. CPC H04N 25/709; G05F 1/46; H02M 3/07; H04N 25/779; H04N 25/79

(57) ABSTRACT

A row driver assembly includes a row driver unit having a plurality of buffer circuits, each buffer circuit including a high buffer supply input and a low buffer supply input and configured to drive a control signal to a pixel circuit that converts incident radiation into an electric signal. A voltage converter unit is coupled to the low buffer supply inputs and includes a voltage regulator circuit and a charge pump circuit. The voltage regulator circuit has an input, an output, and a reference input, with the output coupled to a low buffer supply input of a first buffer circuit. The charge pump circuit has an output coupled to the reference input of the voltage regulator circuit.

The present disclosure relates to a row driver assembly and to a solid-state imaging device. More specifically, the disclosure relates to row driver assemblies for image sensors.

### BACKGROUND

Active image sensors in solid-state imaging devices include photoelectric conversion elements generating a photocurrent with a current rating in proportion to the received radiation intensity. A pixel circuit transforms the small photocurrent generated by the photoelectric conversion element into a comparatively large output voltage which a downstream analog-to-digital converter converts into a digital signal. The pixel circuit includes several transistors receiving control signals generated in a row decoder unit. A row driver assembly includes amplifier circuits that drive the control signals received from the row decoder unit and pass the amplified control signals to the pixel circuits. Row driver assemblies typically include charge pump circuits for generating the low buffer supply voltages for the amplifier circuits. Off-chip capacitors may be electrically coupled to the charge pump circuits. Cost reduction of solid-state imaging devices without any loss of functionality is challenging and requires solutions for reducing chip area of functional blocks and/or board area.

### SUMMARY

The present disclosure has been made in view of the above circumstances.

To this purpose, a row driver assembly includes a row driver unit comprising n buffer circuits, n being an integer larger than 1. Each of the n buffer circuits includes a high buffer supply input and a low buffer supply input and is configured to drive a buffered control signal to a pixel circuit configured to convert incident radiation into an electric signal. The row driver assembly further includes a voltage converter unit electrically coupled to low buffer supply inputs of the n buffer circuits. The voltage converter unit includes a voltage regulator circuit comprising an input, an output, and a reference input. The output of the voltage regulator circuit is electrically coupled to a low buffer supply input of a first buffer circuit of the n buffer circuits. The voltage converter unit further includes a charge pump circuit. An output of the charge pump circuit is electrically coupled to the reference input of the voltage regulator circuit.

A solid-state imaging device includes a chip including the row driver assembly defined above.

### BRIEF DESCRIPTION OF THE DRAWINGS

A more complete appreciation of the disclosure and many of the advantages thereof will be readily obtained as the same becomes better understood by reference to the following detailed description when considered in connection with the accompanying drawings, wherein:

FIGS. 1 to 10 are simplified circuit diagrams depicting exemplary circuit configurations of a row driver assembly according to embodiments of the present technology.

FIG. 11 is a block diagram schematically depicting an outline of a system configuration of a CMOS image sensor which is an example of a solid-state imaging device to which the technology according to the present disclosure is applied.

FIG. 12 is a circuit diagram depicting an exemplary circuit configuration of a pixel circuit.

FIG. 13A is a perspective view schematically depicting a flat chip structure, and FIG. 13B is an exploded perspective view schematically depicting a stacked semiconductor chip structure.

FIG. 14 is a block diagram schematically depicting an exemplary configuration of an analog-to-digital conversion section.

FIG. 15 is a schematic circuit diagram of elements of an image sensor array formed on a second (e.g. circuit) chip of a solid-state imaging device with laminated structure according to an embodiment.

FIG. 16 is a diagram depicting an application example of the technology according to the present disclosure.

FIG. 17 is a block diagram depicting an example of a schematic configuration of a vehicle control system.

FIG. 18 is a diagram of assistance in explaining an example of installation positions of an outside-vehicle information detecting section and an imaging section of the vehicle control system of FIG. 17.

### DETAILED DESCRIPTION

Embodiments for implementing techniques of the present disclosure (also referred to as “embodiments” in the following) will be described below in detail using the drawings. The techniques of the present disclosure are not limited to the described embodiments, and various numerical values and the like in the embodiments are illustrative only. The same elements or elements with the same functions are denoted by the same reference signs.

The terms “having”, “containing”, “including”, “comprising” and the like are open, and the terms indicate the presence of stated structures, elements or features but do not preclude the presence of additional elements or features. The articles “a”, “an” and “the” are intended to include the plural as well as the singular, unless the context clearly indicates otherwise.

Connected electronic elements may be electrically connected through a direct and/or low-resistive connection, e.g., through a conductive line. The terms “electrically connected” and “electrically coupled” may, in addition to a direct electric connection, also include a connection through other electronic elements provided and suitable for permanent and/or temporary signal transmission and/or transmission of energy. For example, electronic elements may be electrically coupled through resistors, capacitors, and switches such as transistors or transistor circuits, e.g. FETs (field effect transistors), transmission gates, and others. The load path of a transistor is the controlled path of a transistor. For example, a voltage applied to a gate of a FET controls by field effect the current flow through the load path between source and drain.

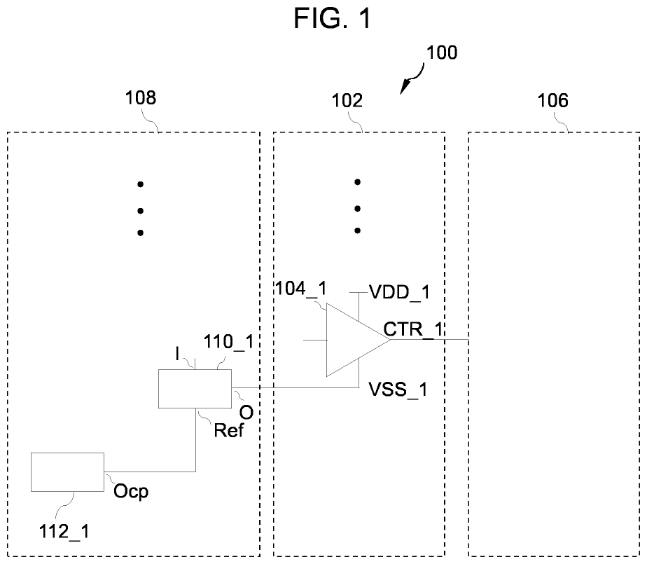

FIG. 1 illustrates a configuration example of a row driver assembly 100 according to an embodiment of the present technology. The row driver assembly 100 may be formed in a chip, e.g. a circuit chip. The chip may include a semiconductor substrate, e.g. a silicon semiconductor substrate, and a wiring area over one or both sides of the semiconductor substrate. While circuit elements, e.g. transistors or diodes, may be integrated in the semiconductor substrate, the wiring area may include one or more than one, e.g. two, three, four or even more wiring levels. Each wiring level may be formed by a single one or a stack of conductive layers, e.g. metal layer(s). The wiring levels may be lithographically patterned, for example. Between stacked wiring levels, an interlayer dielectric structure may be arranged. Contact plug(s) or contact line(s) may be formed in openings in the interlayer dielectric structure to electrically connect parts, e.g. metal lines or contact areas, of different wiring levels to one another. The wiring level may allow for electrically connecting circuit elements to one another for realizing functional circuits, e.g. switches, voltage regulator circuits, buffer circuits, comparators, digital-to-analog converters, analog-to-digital converters, memory elements, charge pumps etc. The wiring level may further allow for providing contact areas configured to be electrically connected from outside of the chip. This may allow for providing the chip with electrical signals from outside of the chip.

The row driver assembly 100 includes a row driver unit 102. The row driver unit 102 includes n buffer circuits, n being an integer larger than 1. A first buffer circuit 104_1 illustrated in FIG. 1 includes a high buffer supply input VDD_1 and a low buffer supply input VSS_1. The first buffer circuit 104_1 is configured to drive a buffered control signal CTR_1 to a pixel circuit 106. The first buffer circuit 104_1 may include an active amplifier circuit supplied with a low buffer supply voltage supplied to the low buffer supply input VSS_1 and a high buffer supply voltage supplied to the high buffer supply input VDD_1. For example, the buffer circuit 104_1 may receive a digital pixel control signal alternating between a buffer input low level and a buffer input high level and output the buffered control signal CTR_1 as a digital buffered pixel control signal alternating between the low buffer supply voltage and the high buffer supply voltage. The first buffer circuit 104_1 may be effective as level-shifter. In particular, the buffer output low level and the buffer input low level may differ from each other and/or the buffer output high level and the buffer input high level differ from each other. The first buffer circuit 104_1 may have a comparatively high input impedance with regard to the pixel control signal and may have comparatively low output impedance with regard to the buffered control signal CTR_B. The high buffer supply input VDD_1 may be electrically connected, e.g. by a high buffer supply voltage line, to an output of a voltage generation unit.

The pixel circuit 106 is configured to convert incident radiation into an electric signal, e.g. by a photodiode. The pixel circuit may be arranged in a pixel array comprising a plurality of pixel circuits arranged in a matrix pattern including, for example, pixel circuit rows and pixel circuit columns. For example, the pixel array may be formed in a pixel chip separate from a circuit chip including the row driver assembly. In this case, the chips may be stacked over one another and may be electrically connected to one another by one or more suitable interconnection techniques. Examples for interconnection techniques include bond wires, flip chip techniques, TSVs (through silicon vias) or TCVs (through chip vias). TSVs or TCVs involve actually creating a separate pathway through the “stack” by chemically etching, or using lasers or other techniques. The chips may be adhered to each other, e.g. by a film adhesive. The interconnection techniques may be combined and the number of stacked chips may be varied and adapted to the specific needs as required. In some examples, the pixel circuit and the row driver assembly may be integrated in one chip, e.g. in one semiconductor substrate. The number n of buffer circuits may depend on the number of required control signals for circuit elements, e.g. transistors such as MOSFETs, in each pixel circuit. Since a variety of pixel circuit designs exist, the number n may be adapted to the specific design of the pixel circuit, for example. The buffered and/or level-shifted control signal may be passed to one single pixel circuit 106, to the pixel circuits of one or more pixel circuit rows, to a portion of a pixel circuit row, or to all pixel circuits of the pixel array.

The row driver assembly 100 further includes a voltage converter unit 108 that is electrically coupled to low buffer supply inputs of the n buffer circuits. In the configuration example of FIG. 1, the voltage converter unit 108 includes a voltage regulator circuit 110_1 comprising an input I, an output O, and a reference input Ref. The output O of the voltage regulator circuit 110_1 is electrically coupled to the low buffer supply input VSS_1 of the first buffer circuit 104_1. The voltage regulator circuit 110_1 may supply the low buffer supply voltage to the low buffer supply input VSS_1 of the first buffer circuit 104_1. For example, the voltage regulator circuit 110_1 may be a low-dropout, LDO, regulator circuit. In some examples, the voltage supplied to the high buffer supply input VDD_1 is equal to the voltage supplied to the input I of the voltage regulator circuit 110_1. In some other examples, the voltage supplied to the high buffer supply input VDD_1 is larger than the voltage supplied to the input I of the of the voltage regulator circuit 110_1. For example, the high buffer supply input VDD_1 may be electrically connected to an output of a voltage generation unit that supplies a larger voltage than another output of the voltage generation unit that is electrically connected to the input I of the voltage regulator circuit 110 1.

The row driver assembly 100 further includes a charge pump circuit 112_1. An output Ocp of the charge pump circuit 112_1 is electrically coupled to the reference input Ref of the voltage regulator circuit 110_1. For example, an input of the charge pump circuit 112_1 may be electrically connected to an external capacitor, e.g. an off-chip capacitor on a circuit board. For example, the charge pump circuit 112_1 may be configured to supply negative voltage levels to the pixel circuit, for example.

As is indicated by the dotted line in FIG. 1, a low buffer supply input of one or more buffer circuits of the n buffer circuits may be electrically coupled to the output Ocp of the charge pump circuit 112_1. For example, a low buffer input of a further buffer circuit may be directly connected to the output Ocp of the charge pump circuit 112_1. In addition or as an alternative, a low buffer input of another buffer circuit may be electrically coupled to the output Ocp of the charge pump circuit 112_1 via another voltage regulator circuit. For example, a reference input of the other voltage regulator circuit may be electrically coupled to the output Ocp of the charge pump circuit 112, or may be electrically coupled to the output O of the voltage regulator circuit 110_1.

The row driver assembly 100 may be formed as part of a chip of a solid-state imaging device. The chip may be a circuit chip, and the solid-state imaging device may further include a pixel chip stacked over the circuit chip, the pixel chip including a plurality of pixel circuits arranged in a matrix pattern. For example, the solid-state imaging device may further include a supply voltage generation unit comprising a plurality of outputs, wherein the supply voltage generation unit is configured to provide supply voltages that differ from one another at the plurality of outputs. The voltage converter unit 108 may include a plurality of voltage regulator circuits, and at least two of the plurality of voltage regulator circuits may include inputs electrically coupled to different outputs of the supply voltage generation unit. For example, high buffer supply inputs of at least two of the n buffer circuits may be electrically coupled to different outputs of the supply voltage generation unit.

The row driver assembly 100 described herein allows for technical benefits such as reducing chip area, noise and costs. For example, the charge pump interacting with the voltage regulator circuit may be used for supplying different low buffer supply voltage levels to the low buffer supply inputs of several buffer circuits. This may allow for reducing the number of charge pump circuits, and hence, chip area. Moreover, the use of the voltage regulator circuit(s), e.g. LDO, may allow for a reduction of noise. In addition to the on-chip benefits, also off-chip benefits, e.g. benefits external from the chip, may be achieved. For example, costs and area of external, e.g. off-chip, capacitors electrically coupled to the charge pumps may be reduced. This may allow for reducing PCB (printed circuit board) area, and thus, PCB manufacturing costs.

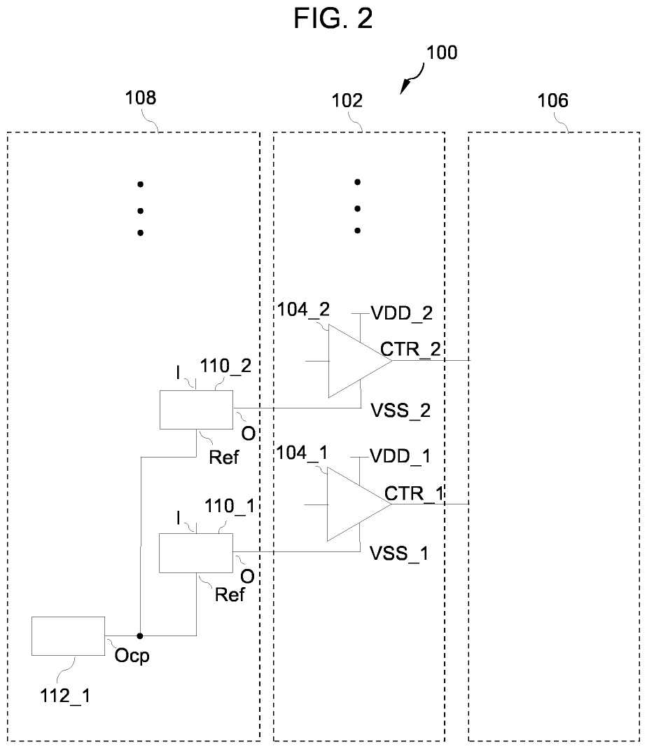

FIG. 2 illustrates a configuration example of a row driver assembly 100 according to another embodiment of the present technology. The row driver assembly 100 of FIG. 2 is based on the row driver assembly 100 illustrated in FIG. 1. The voltage regulator circuit 110_1 is a first voltage regulator circuit. The row driver assembly 100 of the configuration example illustrated in FIG. 2 further includes a second voltage regulator circuit 110_2 comprising an input I, an output O, and a reference input Ref. The output O of the second voltage regulator circuit 110_2 is electrically connected to a low buffer supply input VSS_2 of a second buffer circuit 104_2 of the n buffer circuits. The output Ocp of the charge pump circuit 112_1 is electrically connected to the reference input Ref of the second voltage regulator circuit 110_2. The second voltage regulator circuit 110_1 may supply a low buffer supply voltage to the low buffer supply input VSS_2 of the second buffer circuit 104_2. For example, the second voltage regulator circuit 110_2 may be a low-dropout, LDO, regulator circuit. The circuit configuration of FIG. 2 allows for a flexible supply of low buffer supply voltages to the buffer circuits based on a single charge pump circuit.

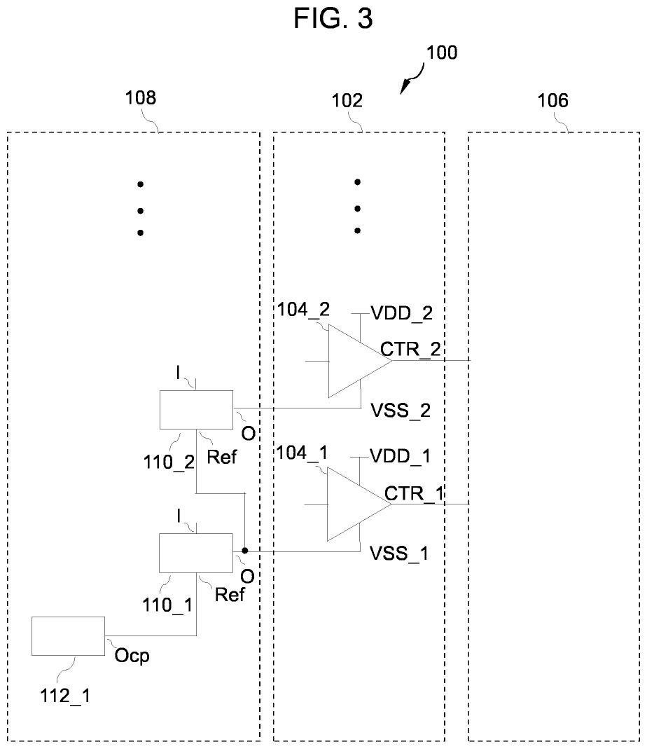

FIG. 3 illustrates a configuration example of a row driver assembly 100 according to another embodiment of the present technology. The row driver assembly 100 of FIG. 3 is based on the row driver assembly 100 illustrated in FIG. 1. The voltage regulator circuit 110_1 is a first voltage regulator circuit. The row driver assembly 100 of the configuration example illustrated in FIG. 3 further includes a second voltage regulator circuit 110_2 comprising an input I, an output O, and a reference input Ref. The output O of the second voltage regulator circuit 110_2 is electrically connected to a low buffer supply input VSS_2 of a second buffer circuit 104_2 of the n buffer circuits. The output O of the first voltage regulator circuit 110_1 is electrically connected to the reference input Ref of the second voltage regulator circuit 110_2. The second voltage regulator circuit 110_2 may supply a low buffer supply voltage to the low buffer supply input VSS_2 of the second buffer circuit 104_2. For example, the second voltage regulator circuit 110_2 may be a low-dropout, LDO, regulator circuit. The circuit configuration of FIG. 3 allows for a flexible supply of low buffer supply voltages to the buffer circuits based on a single charge pump circuit.

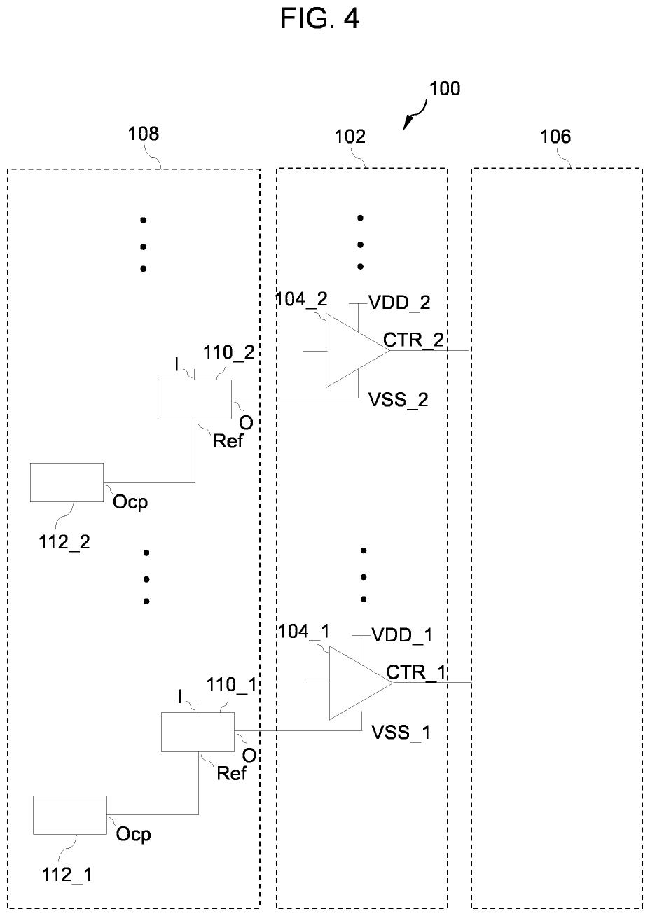

FIG. 4 illustrates a configuration example of a row driver assembly 100 according to another embodiment of the present technology. The row driver assembly 100 of FIG. 4 is based on the row driver assembly 100 illustrated in FIG. 1. The voltage regulator circuit 110_1 is a first voltage regulator circuit. The charge pump circuit 112_1 is a first charge pump circuit 112_1. The row driver assembly 100 of the configuration example illustrated in FIG. 4 further includes a second charge pump circuit 112_2, a second voltage regulator circuit 110_2 comprising an input I, an output O, and a reference input Ref. The output O of the second voltage regulator circuit 110_2 is electrically connected to a low buffer supply input VSS_2 of a second buffer circuit 104_2 of the n buffer circuits. The second voltage regulator circuit 110_2 may supply a low buffer supply voltage to the low buffer supply input VSS_2 of the second buffer circuit 104_2. For example, the second voltage regulator circuit 110_2 may be a low-dropout, LDO, regulator circuit.

An output Ocp of the second charge pump circuit 112_2 is electrically connected to the reference input Ref of the second voltage regulator circuit 110_2.

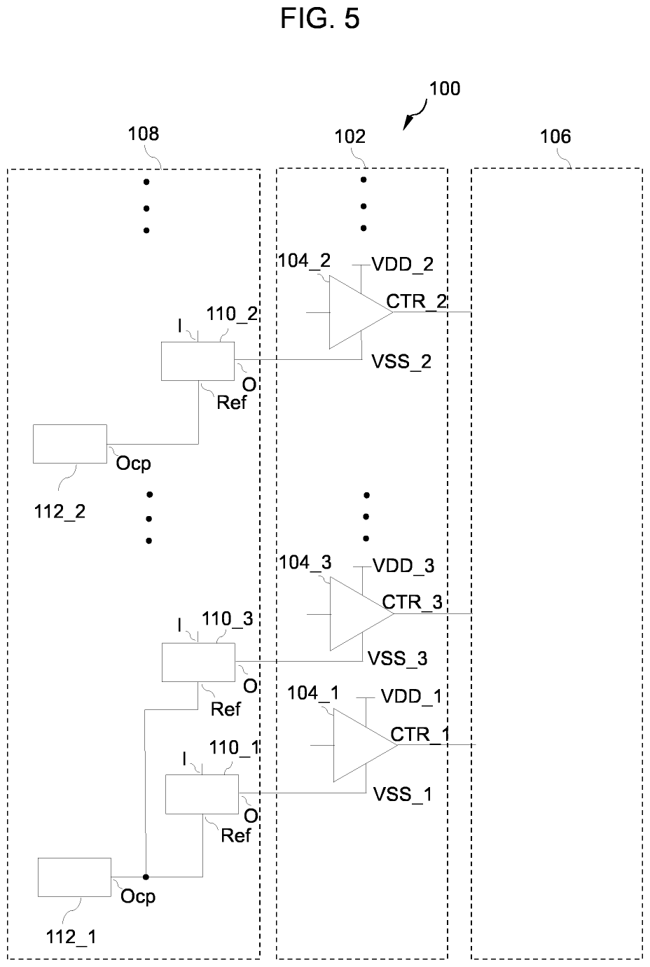

FIG. 5 illustrates a configuration example of a row driver assembly 100 according to another embodiment of the present technology. The row driver assembly 100 of FIG. 5 is based on the row driver assembly 100 illustrated in FIG. 4. The row driver assembly 100 of the configuration example illustrated in FIG. 5 further includes a third voltage regulator circuit 110_3 comprising an input I, an output O, and a reference input Ref. The output O of the third voltage regulator circuit 110_3 is electrically connected to a low buffer supply input VSS_3 of a third buffer circuit 104_3 of the n buffer circuits. The third voltage regulator circuit 110_3 may supply a low buffer supply voltage to the low buffer supply input VSS_3 of the third buffer circuit 104_3.

The output Ocp of the first charge pump circuit 112_1 is electrically coupled to the reference input Ref of the third voltage regulator circuit 110_3 (similar to the interconnection illustrated in the circuit configuration of FIG. 2).

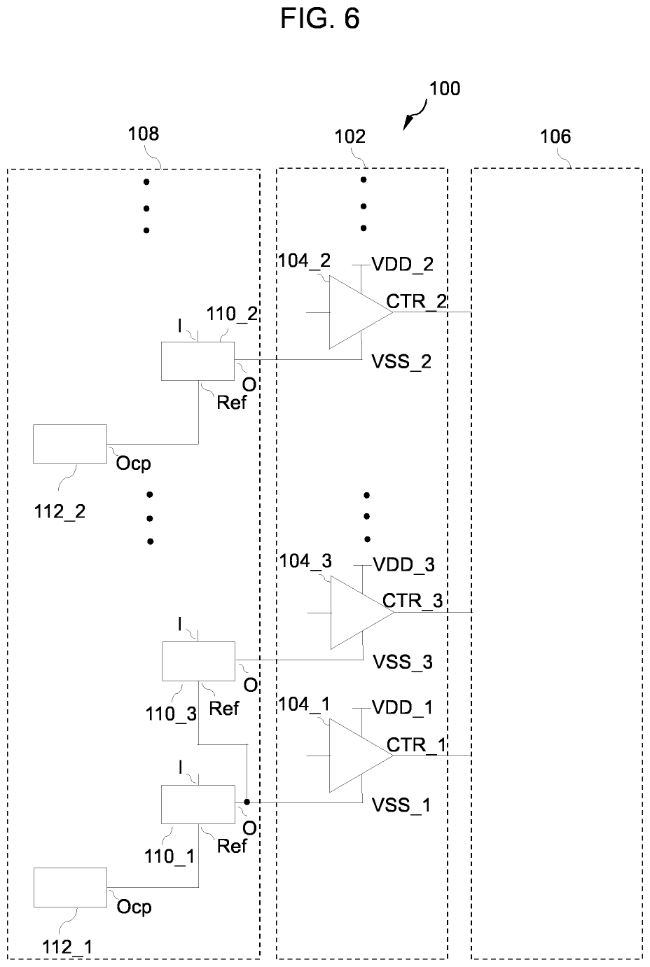

FIG. 6 illustrates a configuration example of a row driver assembly 100 according to another embodiment of the present technology. The row driver assembly 100 of FIG. 6 is based on the row driver assembly 100 illustrated in FIG. 4. The row driver assembly 100 of the configuration example illustrated in FIG. 6 further includes a third voltage regulator circuit 110_3 comprising an input I, an output O, and a reference input Ref. The output O of the third voltage regulator circuit 110_3 is electrically connected to a low buffer supply input VSS_3 of a third buffer circuit 104_3 of the n buffer circuits. The third voltage regulator circuit 110_3 may supply a low buffer supply voltage to the low buffer supply input VSS_3 of the third buffer circuit 104_3.

The output O of the first voltage regulator circuit 110_1 is electrically connected to the reference input Ref of the third voltage regulator circuit 110_3 (similar to the interconnection illustrated in the circuit configuration of FIG. 3).

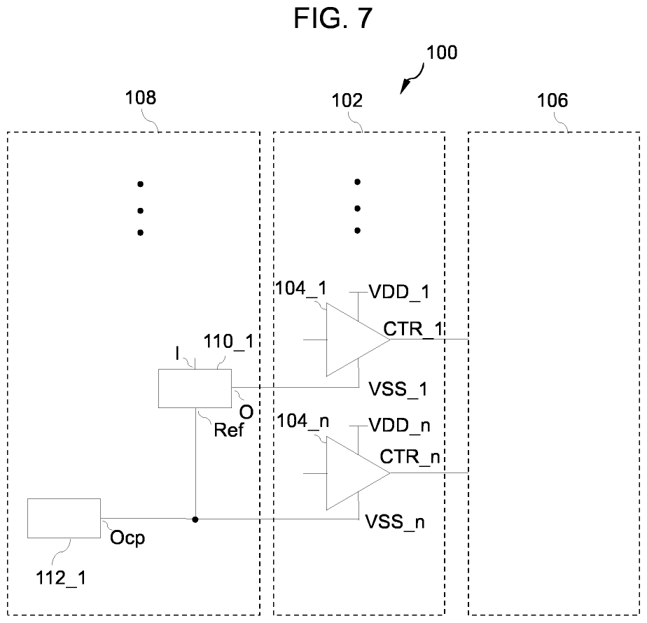

FIG. 7 illustrates a configuration example of a row driver assembly 100 according to another embodiment of the present technology. The row driver assembly 100 of FIG. 7 is based on the row driver assembly 100 illustrated in FIG. 1. In the row driver assembly 100 of the configuration example illustrated in FIG. 7, the output Ocp of the charge pump circuit 112_1 is electrically connected to a low buffer supply input VSS_n of an n-th buffer circuit 104_n of the n buffer circuits. The charge pump 112_1 may supply a low buffer supply voltage to the low buffer supply input VSS_n of the n-th buffer circuit 104_n without any intermediate voltage regulator circuit.

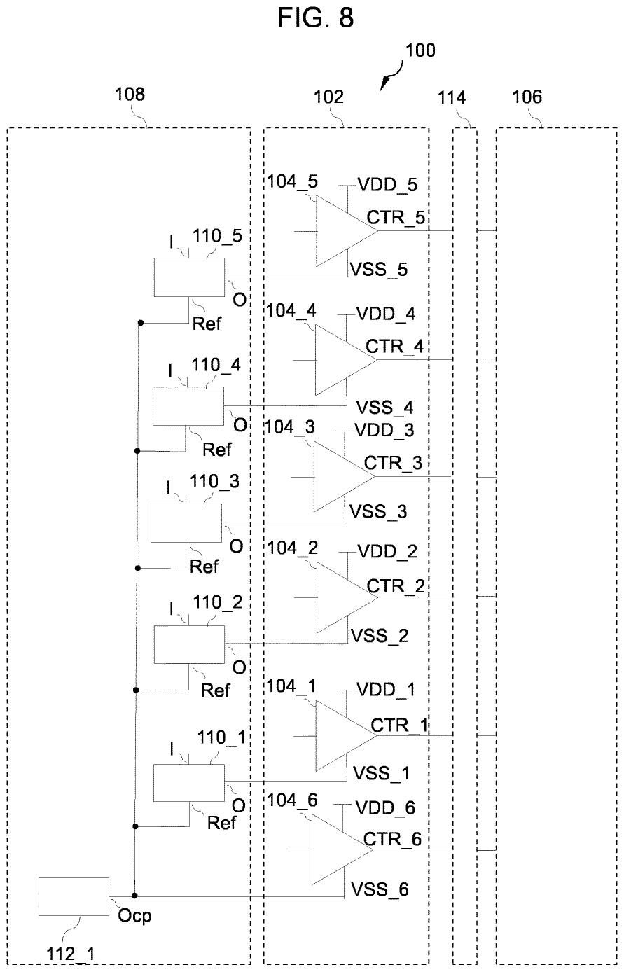

FIG. 8 illustrates a configuration example of a row driver assembly 100 according to another embodiment of the present technology. The row driver assembly 100 of FIG. 8 is based on the row driver assembly 100 illustrated in FIG. 2 and is one example of a row driver unit 102 including six driver circuits, e.g. for supplying six control signals to the pixel circuit 106.

The row driver assembly 100 of the configuration example illustrated in FIG. 8 further includes a third voltage regulator circuit 110_3 comprising an input I, an output O, and a reference input Ref. The output O of the third voltage regulator circuit 110_3 is electrically connected to a low buffer supply input VSS_3 of a third buffer circuit 104 3 of the six buffer circuits. The output Ocp of the charge pump circuit 112_1 is electrically connected to the reference input Ref of the third voltage regulator circuit 110_3. The third voltage regulator circuit 110_3 may supply a low buffer supply voltage to the low buffer supply input VSS_3 of the third buffer circuit 104_3. For example, the third voltage regulator circuit 110_3 may be a low-dropout, LDO, regulator circuit.

The row driver assembly 100 of the configuration example illustrated in FIG. 8 further includes a fourth voltage regulator circuit 110_4 comprising an input I, an output O, and a reference input Ref. The output O of the fourth voltage regulator circuit 110_4 is electrically connected to a low buffer supply input VSS_4 of a fourth buffer circuit 104_4 of the six buffer circuits. The output Ocp of the charge pump circuit 112_1 is electrically connected to the reference input Ref of the fourth voltage regulator circuit 110_4. The fourth voltage regulator circuit 110_4 may supply a low buffer supply voltage to the low buffer supply input VSS_4 of the fourth buffer circuit 104_4. For example, the fourth voltage regulator circuit 110_4 may be a low-dropout, LDO, regulator circuit.

The row driver assembly 100 of the configuration example illustrated in FIG. 8 further includes a fifth voltage regulator circuit 110_5 comprising an input I, an output O, and a reference input Ref. The output O of the fifth voltage regulator circuit 110_5 is electrically connected to a low buffer supply input VSS_5 of a fifth buffer circuit 104_5 of the six buffer circuits. The output Ocp of the charge pump circuit 112_1 is electrically connected to the reference input Ref of the fifth voltage regulator circuit 110_5. The fifth voltage regulator circuit 110_5 may supply a low buffer supply voltage to the low buffer supply input VSS_5 of the fifth buffer circuit 104_5. For example, the fifth voltage regulator circuit 110_5 may be a low-dropout, LDO, regulator circuit.

In the row driver assembly 100 of the configuration example illustrated in FIG. 8, the output Ocp of the charge pump circuit 112_1 is electrically connected to a low buffer supply input VSS_6 of a sixth buffer circuit 104_6 of the six buffer circuits. The charge pump 112_1 may supply a low buffer supply voltage to the low buffer supply input VSS_6 of the sixth buffer circuit 104_6 without any intermediate voltage regulator circuit.

The row driver assembly 100 of the configuration example illustrated in FIG. 8 further includes a control signal switching unit 114 electrically coupled between the row driver unit 102 and the pixel circuit 106. The control signal switching unit may allow for a flexible distribution of the control signals to pixel circuit elements, e.g. gates of MOSFETs, of the pixel circuit 6.

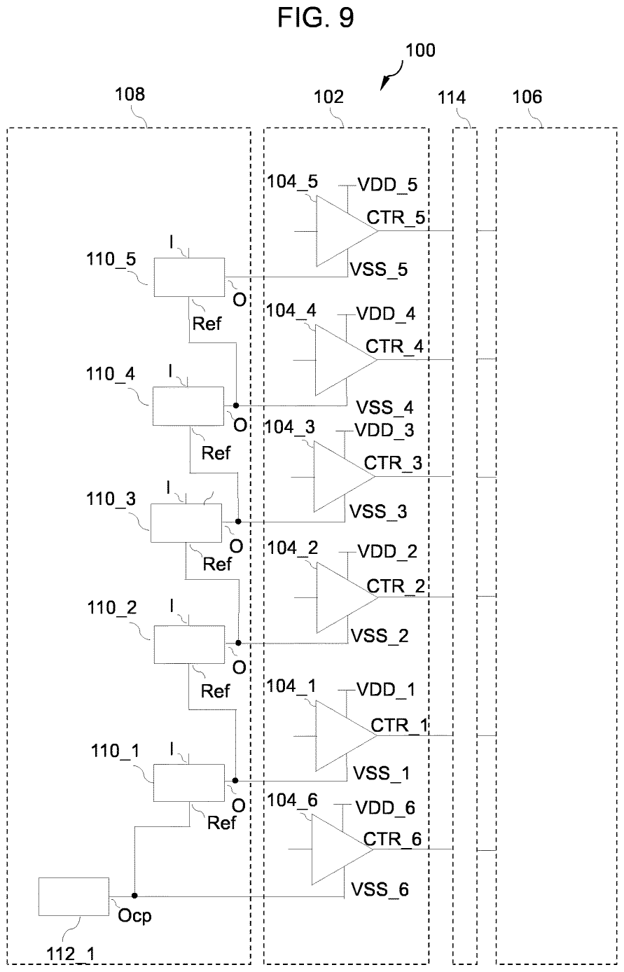

FIG. 9 illustrates a configuration example of a row driver assembly 100 according to another embodiment of the present technology. The row driver assembly 100 of FIG. 9 is based on the row driver assembly 100 illustrated in FIG. 3 and is one example of a row driver unit 102 including six driver circuits, e.g. for supplying six control signals to the pixel circuit.

The row driver assembly 100 of the configuration example illustrated in FIG. 9 further includes a third voltage regulator circuit 110_3 comprising an input I, an output O, and a reference input Ref. The output O of the third voltage regulator circuit 110_3 is electrically connected to a low buffer supply input VSS_3 of a third buffer circuit 104_3 of the six buffer circuits. The output O of the second voltage regulator circuit 110_2 is electrically connected to the reference input Ref of the third voltage regulator circuit 110_3. The third voltage regulator circuit 110_3 may supply a low buffer supply voltage to the low buffer supply input VSS_3 of the third buffer circuit 104_3. For example, the third voltage regulator circuit 110_3 may be a low-dropout, LDO, regulator circuit.

The row driver assembly 100 of the configuration example illustrated in FIG. 9 further includes a fourth voltage regulator circuit 110_4 comprising an input I, an output O, and a reference input Ref. The output O of the fourth voltage regulator circuit 110_4 is electrically connected to a low buffer supply input VSS_4 of a fourth buffer circuit 104_4 of the six buffer circuits. The output O of the third voltage regulator circuit 110_3 is electrically connected to the reference input Ref of the fourth voltage regulator circuit 110_4. The fourth voltage regulator circuit 110_4 may supply a low buffer supply voltage to the low buffer supply input VSS_4 of the fourth buffer circuit 104_4. For example, the fourth voltage regulator circuit 110_4 may be a low-dropout, LDO, regulator circuit.

The row driver assembly 100 of the configuration example illustrated in FIG. 9 further includes a fifth voltage regulator circuit 110_5 comprising an input I, an output O, and a reference input Ref. The output O of the fifth voltage regulator circuit 110_5 is electrically connected to a low buffer supply input VSS_5 of a fifth buffer circuit 104_5 of the six buffer circuits. The output O of the fourth voltage regulator circuit 110_4 is electrically connected to the reference input Ref of the fifth voltage regulator circuit 110_5. The fifth voltage regulator circuit 110_5 may supply a low buffer supply voltage to the low buffer supply input VSS_5 of the fifth buffer circuit 104_5. For example, the fifth voltage regulator circuit 110_5 may be a low-dropout, LDO, regulator circuit.

In the row driver assembly 100 of the configuration example illustrated in FIG. 9, the output Ocp of the charge pump circuit 112_1 is electrically connected to a low buffer supply input VSS_6 of a sixth buffer circuit 104_6 of the six buffer circuits. The charge pump 112_1 may supply a low buffer supply voltage to the low buffer supply input VSS_6 of the sixth buffer circuit 104_6 without any intermediate voltage regulator circuit.

The row driver assembly 100 of the configuration example illustrated in FIG. 9 further includes a control signal switching unit 114 electrically coupled between the row driver unit 102 and the pixel circuit 106. The control signal switching unit may allow for a flexible distribution of the control signals to pixel circuit elements, e.g. gates of MOSFETs, of the pixel circuit 6.

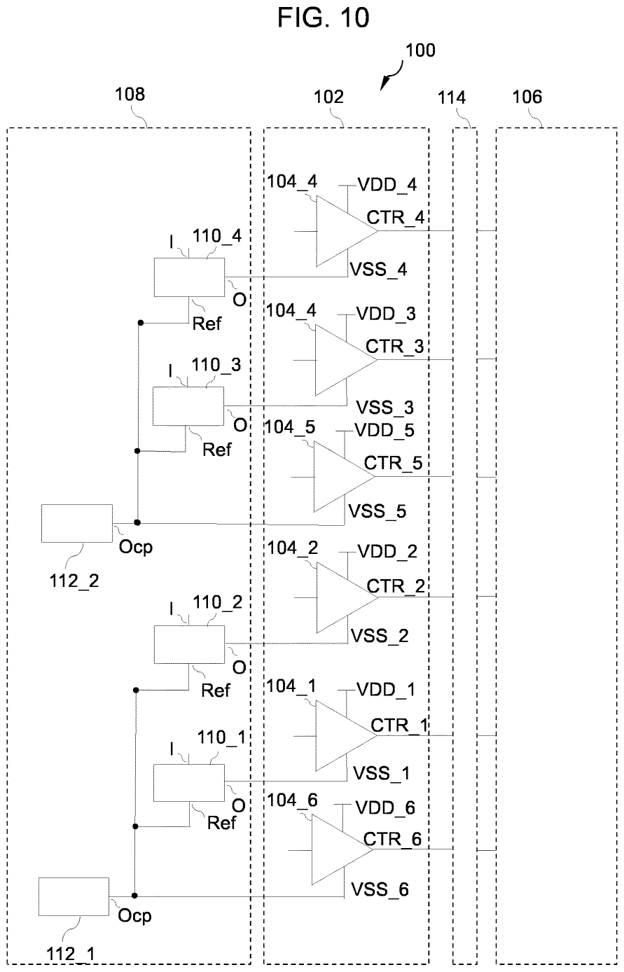

FIG. 10 illustrates a configuration example of a row driver assembly 100 according to another embodiment of the present technology. The row driver assembly 100 of FIG. 10 is based on the row driver assembly 100 illustrated in FIG. 5 and is one example of a row driver unit 102 including six driver circuits, e.g. for supplying six control signals to the pixel circuit.

In the configuration example of FIG. 10, the output Ocp of the first charge pump circuit 112_1 is electrically connected to a low buffer supply input VSS_6 of a sixth buffer circuit 104_6, to a reference input Ref of a first voltage regulator circuit 110_1, and to a to a reference input Ref of a second voltage regulator circuit 110_2. Likewise, the output Ocp of the second charge pump circuit 112_2 is electrically connected to a low buffer supply input VSS_5 of a fifth buffer circuit 104_5, to a reference input Ref of a third voltage regulator circuit 110_3, and to a to a reference input Ref of a fourth voltage regulator circuit 110_4.

Similar to the circuit configurations described above, an output O of the first voltage regulator circuit 110_1 is electrically connected to a low buffer supply input VSS_1 of a first buffer circuit 104_1 of the six buffer circuits. An output O of the second voltage regulator circuit 110_2 is electrically connected to a low buffer supply input VSS_2 of a second buffer circuit 104_2 of the six buffer circuits. An output O of the third voltage regulator circuit 110_3 is electrically connected to a low buffer supply input VSS_3 of a third buffer circuit 104_3 of the six buffer circuits. An output O of the fourth voltage regulator circuit 110_4 is electrically connected to a low buffer supply input VSS_4 of a fourth buffer circuit 104_4 of the six buffer circuits.

The row driver assembly 100 of the configuration example illustrated in FIG. 10 further includes a control signal switching unit 114 electrically coupled between the row driver unit 102 and the pixel circuit 106. The control signal switching unit may allow for a flexible distribution of the control signals to pixel circuit elements, e.g. gates of MOSFETs, of the pixel circuit 6.

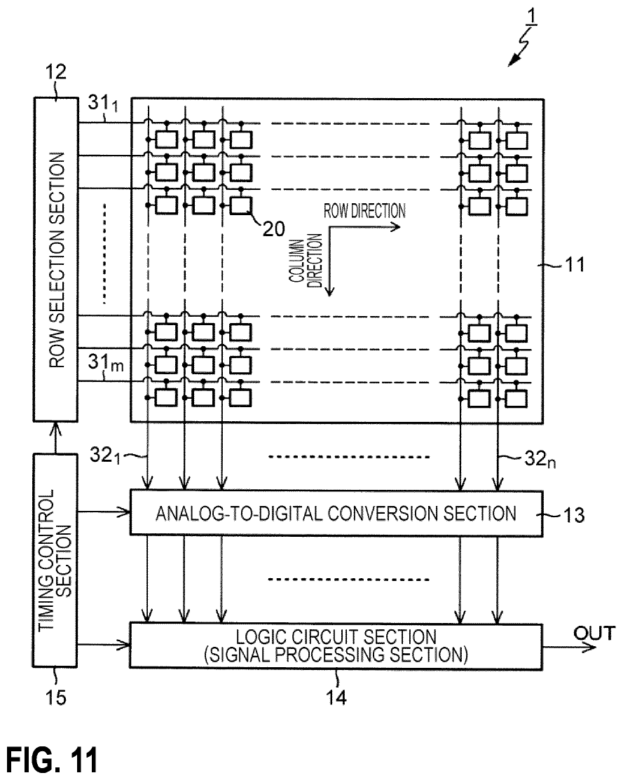

FIG. 11 is a block diagram schematically depicting an outline of a system configuration of the CMOS image sensor which is an example of a solid-state imaging device to which the technology according to the present disclosure is applied.

A CMOS image sensor 1 may include a pixel array section 11 and a peripheral circuit section of the pixel array section 11. The pixel array section 11 has a configuration in which pixels (pixel circuits) 20 including light receiving elements are two-dimensionally arranged in a row direction and a column direction, that is, in a matrix. Here, the row direction refers to an array direction of the pixels 20 in a pixel row, and the column direction refers to an array direction of the pixels 20 in a pixel column. The pixel 20 performs photoelectric conversion to generate and accumulate a photocharge corresponding to the amount of received light.

The peripheral circuit section of the pixel array section 11 includes, for example, a row selection section 12, an analog-to-digital conversion section 13, a logic circuit section 14 as a signal processing section, a timing control section 15, and the like. The peripheral section may include the row driver assembly 100 as described in the embodiments of the present disclosure, e.g. as part of the row selection section 12. The peripheral section may further include a supply voltage generation unit configured to supply different voltages to inputs of the voltage converter circuits or high buffer supply inputs of buffer circuits of the row driver assembly according to the embodiments described herein.

In the pixel array section 11, pixel control lines 31 (31₁ to 31ₘ) are wired along the row direction for each pixel row with respect to the matrix-shaped pixel array. Furthermore, vertical signal lines 32 (32₁ to 32ₙ) are wired along the column direction for each pixel column. The pixel control line 31 transmits a drive signal for performing driving at the time of reading a signal from the pixel 20. The pixel control line 31 is illustrated as one wiring in FIG. 11, but is not limited to one. The pixel control line 31 has one end connected to an output end corresponding to each row of the row selection section 12.

Hereinafter, the respective constituent elements of the peripheral circuit section of the pixel array section 11, that is, the row selection section 12, the analog-to-digital conversion section 13, the logic circuit section 14, and the timing control section 15 will be described.

The row selection section 12 includes a shift register, an address decoder, and the like, and controls scanning of pixel rows and addresses of pixel rows in selection of each of the pixels 20 of the pixel array section 11. The row selection section 12 generally includes two scanning systems of a reading scanning system and a sweeping scanning system although a specific configuration thereof is not illustrated.

The reading scanning system sequentially selects and scans the pixels 20 of the pixel array section 11 row by row in order to read a pixel signal from the pixel 20. The pixel signal read from the pixel 20 is an analog signal. The sweeping scanning system performs sweeping scanning on a reading row on which reading scanning is to be performed by the reading scanning system prior to the reading scanning by a time corresponding to a shutter speed.

The sweeping scanning performed by the sweeping scanning system sweeps out unnecessary charges from photoelectric conversion elements of the pixels 20 in the reading row, whereby the photoelectric conversion elements are reset. Then, a so-called electronic shutter operation is performed by sweeping out (resetting) the unnecessary charges by the sweeping scanning system. Here, the electronic shutter operation refers to an operation of sweeping out photocharges of photoelectric conversion elements and newly starting exposure (starting accumulation of photocharges).

The analog-to-digital conversion section 13 includes a set of a plurality of analog-to-digital converters (ADC) provided to correspond to the pixel columns (for example, for each pixel column) of the pixel array section 11. The analog-to-digital conversion section 13 is a column-parallel analog-to-digital conversion section that converts an analog pixel signal output through each of the signal lines 32₁ to 32ₙ into a digital signal for each pixel column.

As the analog-to-digital converter in the analog-to-digital conversion section 13, it is possible to use, for example, a single-slope analog-to-digital converter, which is an example of a reference signal comparison analog-to-digital converter.

The logic circuit section 14, which is the signal processing section, reads the pixel signal digitized by the analog-to-digital conversion section 13 and performs predetermined signal processing. Specifically, as the predetermined signal processing, the logic circuit section 14 performs, for example, correction of a vertical line defect and a point defect or clamping of a signal, and further, digital signal processing such as parallel-to-serial conversion, compression, encoding, addition, averaging, or intermittent operation. The logic circuit section 14 outputs generated image data to a subsequent device as an output signal OUT of the CMOS image sensor 1.

The timing control section 15 generates various timing signals, clock signals, control signals, and the like on the basis of a synchronization signal provided from the outside. Then, the timing control section 15 controls driving of the row selection section 12, the analog-to-digital conversion section 13, the logic circuit section 14, and the like on the basis of the generated signals.

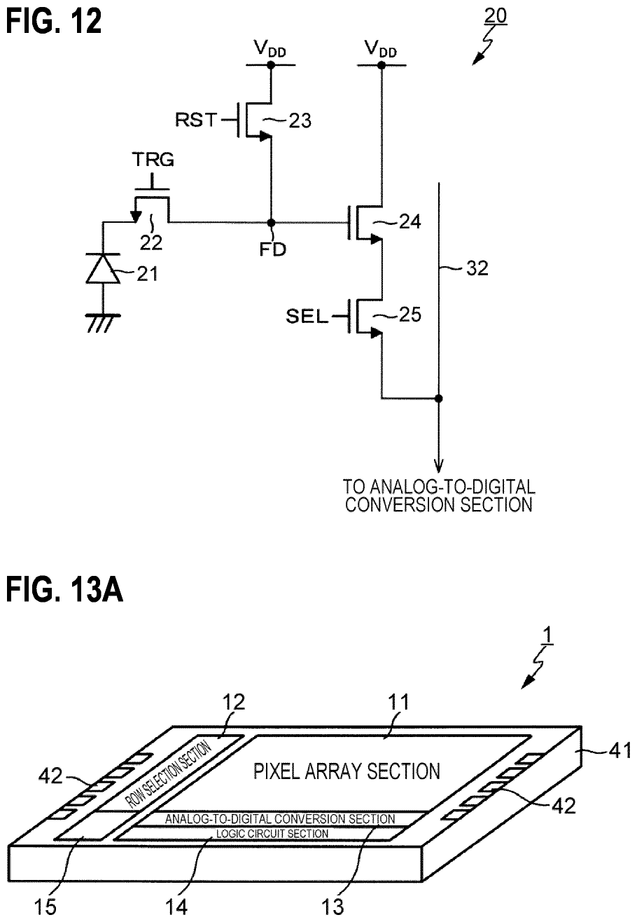

FIG. 12 is a circuit diagram depicting an exemplary circuit configuration of the pixel or pixel circuit 20. The pixel 20 includes, for example, a photodiode 21 as the photoelectric conversion element. The pixel 20 includes a transfer transistor 22, a reset transistor 23, an amplification transistor 24, and a selection transistor 25 in addition to the photodiode 21. Other pixel circuit designs that may be based on a different number of transistors per pixel circuit may likewise be used. When using a different number of transistors per pixel circuit, the number n of the buffer circuits of the row driver assembly described in the embodiments of the present disclosure may be adapted, for example.

As the four transistors of the transfer transistor 22, the reset transistor 23, the amplification transistor 24, and the selection transistor 25, for example, N-channel MOS field-effect transistors are used. However, a combination of conductivity types of the four transistors 22 to 25 exemplified here is merely an example, and the combination is not limited thereto.

For the pixel 20, as the above-described pixel control lines 31 (31₁ to 31ₘ), a plurality of pixel control lines is wired in common to the respective pixels 20 in the same pixel row. The plurality of pixel control lines is connected to an output end corresponding to each pixel row of the row selection section 12 in units of pixel rows. The row selection section 12, e.g. the row driver assembly as defined in the embodiments of the present disclosure, appropriately outputs a transfer signal TRG, a reset signal RST, and a selection signal SEL to the plurality of pixel control lines.

The photodiode 21 has an anode electrode connected to a low-potential-side power supply (for example, ground), photoelectrically converts received light into photocharges (here, photoelectrons) of a charge amount corresponding to the amount of the light, and accumulates the photocharges. The photodiode 21 has a cathode electrode electrically connected to a gate electrode of the amplification transistor 24 via the transfer transistor 22. Here, a region where the gate electrode of the amplification transistor 24 is electrically connected is a floating diffusion (floating diffusion region/impurity diffusion region) FD. The floating diffusion FD is a charge-voltage conversion section that converts a charge into a voltage.

The transfer signal TRG activated at a high level (for example, V_{DD} level) is supplied from the row selection section 12 to a gate electrode of the transfer transistor 22. The transfer transistor 22 is brought into a conductive state in response to the transfer signal TRG, thereby transferring the photocharges, photoelectrically converted by the photodiode 21 and accumulated in the photodiode 21, to the floating diffusion FD.

The reset transistor 23 is connected between a node of a high-potential-side power supply voltage V_{DD} and the floating diffusion FD. The reset signal RST that is activated at a high level is provided from the row selection section 12 to a gate electrode of the reset transistor 23. The reset transistor 23 is brought into a conductive state in response to the reset signal RST, and resets the floating diffusion FD by sweeping out charges of the floating diffusion FD to the node of the voltage V_{DD}.

The amplification transistor 24 has the gate electrode connected to the floating diffusion FD and a drain electrode connected to the node of the high-potential-side power supply voltage V_{DD}. The amplification transistor 24 serves as an input section of a source-follower that reads a signal obtained by photoelectric conversion in the photodiode 21. That is, the amplification transistor 24 has a source electrode connected to the signal line 32 via the selection transistor 25.

The selection transistor 25 has a drain electrode connected to the source electrode of the amplification transistor 24 and a source electrode connected to the signal line 32. The selection signal SEL that is activated at a high level is provided from the row selection section 12 to a gate electrode of the selection transistor 25. The selection transistor 25 is brought into a conductive state in response to the selection signal SEL, thereby transmitting the signal output from the amplification transistor 24 to the signal line 32 with the pixel 20 in a selected state.

Note that the pixel 20 adopting a 4-Tr configuration including four transistors, that is, the transfer transistor 22, the reset transistor 23, the amplification transistor 24, and the selection transistor 25 has been exemplified in the above-described circuit example, but the present invention is not limited thereto. For example, a 3-Tr configuration in which the selection transistor 25 is omitted and the amplification transistor 24 also functions as the selection transistor 25 can also be adopted, and a 5-Tr, or 6-Tr, or more configuration in which the number of transistors is increased can also be adopted as necessary.

As a semiconductor chip structure of the CMOS image sensor 1 having the above-described configuration, a flat semiconductor chip structure and a stacked semiconductor chip structure can be exemplified. Furthermore, regarding a pixel structure, assuming that a substrate surface on a side on which a wiring layer is formed is defined as a front surface (front), it is possible to adopt a back surface irradiation pixel structure which captures light irradiated from a back surface side on the opposite side, or a front surface irradiation pixel structure which captures light irradiated from the front surface side.

Hereinafter, an outline of the flat semiconductor chip structure and the stacked semiconductor chip structure will be described.

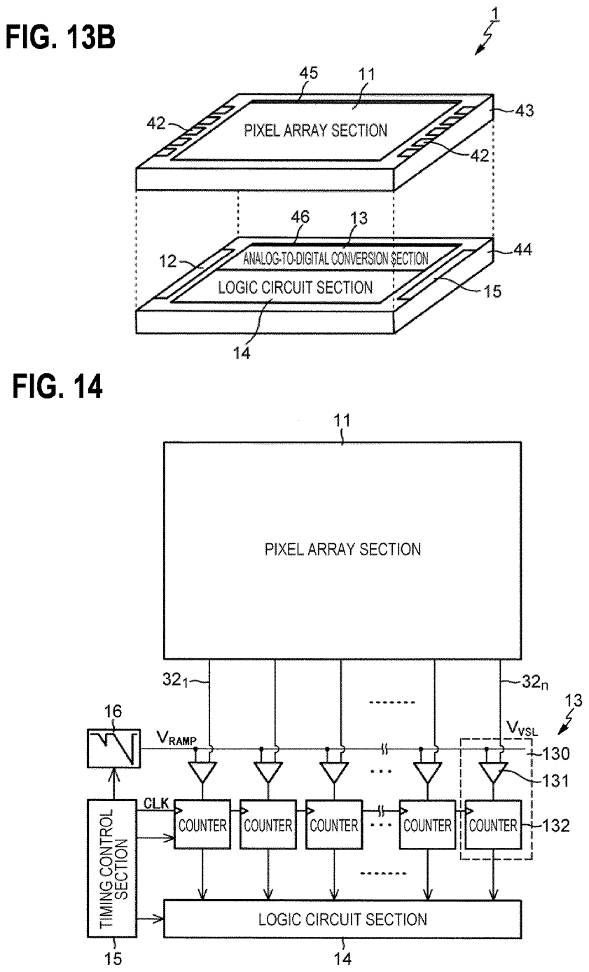

FIG. 13A is a perspective view schematically depicting the flat chip structure of the CMOS image sensor 1. As depicted in FIG. 13A, the flat semiconductor chip structure has a structure in which the respective constituent elements of the peripheral circuit section of the pixel array section 11 are formed on the same semiconductor substrate 41 as the pixel array section 11 in which the pixels (pixel circuits) 20 are arranged in a matrix. Specifically, the row selection section 12, the analog-to-digital conversion section 13, the logic circuit section 14, the timing control section 15, and the like are formed on the same semiconductor substrate 41 as the pixel array section 11. Pads 42 for external connection and power supply are provided, for example, at both left and right ends of the semiconductor chip 41 of the first layer.

Hereinafter, an outline of the stacked semiconductor chip structure will be described.

FIG. 13B is an exploded perspective view schematically depicting the stacked semiconductor chip structure of the CMOS image sensor 1. As depicted in FIG. 13, the stacked semiconductor chip structure, that is, the stacked structure has a structure in which at least two semiconductor chips of a semiconductor chip 43 of the first layer and a semiconductor chip 44 of the second layer are stacked.

In this stacked semiconductor chip structure, the semiconductor chip 43 of the first layer is a pixel chip in which the pixel array section 11 in which the pixels 20 including photoelectric conversion elements (for example, the photodiodes 21) are two-dimensionally arranged in a matrix is formed. The pads 42 for external connection and power supply are provided, for example, at both left and right ends of the semiconductor chip 43 of the first layer. The semiconductor chip 44 of the second layer is a circuit chip in which the peripheral circuit section of the pixel array section 11, that is, the row selection section 12, the analog-to-digital conversion section 13, the logic circuit section 14, the timing control section 15, and the like are formed. Note that the arrangement of the row selection section 12, the analog-to-digital conversion section 13, the logic circuit section 14, and the timing control section 15 is an example, and is not limited to this arrangement example.

The pixel array section 11 on the semiconductor chip 43 of the first layer and the peripheral circuit section on the semiconductor chip 44 of the second layer are electrically connected via junction portions 72 and 73 including a metal-metal junction including a Cu—Cu junction, a through silicon via (TSV), a micro-bump, and the like.

According to the stacked semiconductor chip structure described above, a process suitable for manufacturing the pixel array section 11 can be applied to the semiconductor chip 43 of the first layer, and a process suitable for manufacturing the circuit part can be applied to the semiconductor chip 44 of the second layer. Therefore, the processes can be optimized in manufacturing the CMOS image sensor 1. Therefore, the processes can be optimized in manufacturing the CMOS image sensor 1. In particular, an advanced process can be applied to manufacture the circuit part.

Next, an exemplary configuration of the analog-to-digital conversion section 13 will be described. Here, a single-slope analog-to-digital converter is used as each analog-to-digital converter of the analog-to-digital conversion section 13.

FIG. 14 illustrates the exemplary configuration of the analog-to-digital conversion section 13. In the CMOS image sensor 1, the analog-to-digital conversion section 13 includes a set of a plurality of single-slope analog-to-digital converters provided to respectively correspond to pixel columns of the pixel array section 11. Here, a single-slope analog-to-digital converter 130 of the n-th column will be described as an example.

The analog-to-digital converter 130 has a circuit configuration including a comparator 131 and a counter 132. Then, in the single-slope analog-to-digital converter 130, a reference signal generated by a reference signal generating section 16 is used. The reference signal generating section 16 includes, for example, a digital-to-analog converter (DAC), generates a reference signal V_{RAMP} of a sloped waveform (so-called ramp wave) whose level (voltage) monotonously decreases with the passage of time, and provides the reference signal V_{RAMP} to the comparator 131 provided for each pixel column as a standard signal.

The comparator 131 uses an analog pixel signal V_{VSL} read from the pixel 20 as a comparison input and the reference signal V_{RAMP} of the ramp wave generated by the reference signal generating section 16 as a reference input to compares both the signals. Then, for example, an output of the comparator 131 is in a first state (high level) when the reference signal V_{RAMP} is more than the pixel signal V_{VSL}, and an output is in a second state (for example, low level) when the reference signal V_{RAMP} is equal to or less than the pixel signal V_{VSL}. Therefore, the comparator 131 outputs, as a comparison result, a pulse signal having a pulse width according to a signal level of the pixel signal V_{VSL}, specifically, corresponding to the magnitude of the signal level.

A clock signal CLK is supplied from the timing control section 15 to the counter 132 at the same timing as a supply start timing of the reference signal V_{RAMP} to the comparator 131. Then, the counter 132 performs a counting operation in synchronization with the clock signal CLK to measure a period of a pulse width of an output pulse of the comparator 131, that is, a period from the start of a comparison operation to the end of the comparison operation. A count result (count value) of the counter 132 is supplied to the logic circuit section 14 as a digital value obtained by digitizing the analog pixel signal V_{VSL}.

According to the analog-to-digital conversion section 13 including the set of single-slope analog-to-digital converters 130 described above, it is possible to obtain a digital value from time information until a magnitude relationship between the reference signal V_{RAMP} of the ramp wave generated by the reference signal generating section 16 and the analog pixel signal V_{VSL} read from the pixel 20 through the signal line 32 changes.

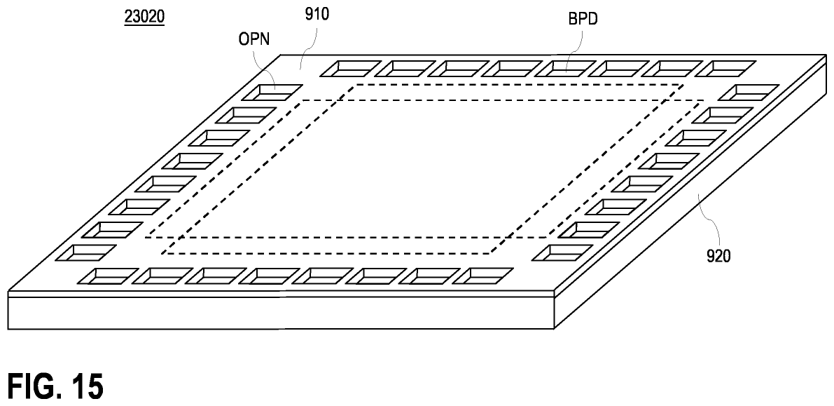

FIG. 15 is a perspective view showing an example of a laminated structure of a solid-state imaging device 23020 with a plurality of pixels arranged matrix-like in array form. Each pixel includes at least one photoelectric conversion element.

The solid-state imaging device 23020 has the laminated structure of a first chip (upper chip) 910 and a second chip (lower chip) 920. The laminated first and second chips 910, 920 may be electrically connected to each other through TC(S)Vs (Through Contact (Silicon) Vias) formed in the first chip 910. The solid-state imaging device 23020 may be formed to have the laminated structure in such a manner that the first and second chips 910 and 920 are bonded together at wafer level and cut out by dicing.

In the laminated structure of the upper and lower two chips, the first chip 910 may be an analog chip (sensor chip) including at least one analog component of each pixel circuit, e.g., the photoelectric conversion elements arranged in array form.

For example, the first chip 910 may include only the photoelectric conversion elements of the pixel circuits as described above with reference to the preceding FIGS. Alternatively, the first chip 910 may include further elements of each pixel circuit. For example, the first chip 910 may include, in addition to the photoelectric conversion elements, at least the transfer transistor, the reset transistor, the amplifier transistor, and/or the selection transistor of the pixel circuits. Alternatively, the first chip 910 may include each element of the pixel circuit.

The second chip 920 may be mainly a logic chip (digital chip) that includes the elements complementing the elements on the first chip 910 to complete pixel circuits and current control circuits. The second chip 920 may also include analog circuits, for example circuits that quantize analog signals transferred from the first chip 910 through the TCVs. For example, the second chip 920 may include all or at least some of the components of the row driver assembly as described in the embodiments herein.

The second chip 920 may have one or more bonding pads BPD and the first chip 910 may have openings OPN for use in wire-bonding to the second chip 920. The solid-state imaging device 23020 with the laminated structure of the two chips 910, 920 may have the following characteristic configuration:

The electrical connection between the first chip 910 and the second chip 920 is performed through, for example, the TCVs. The TCVs may be arranged at chip ends or between a pad region and a circuit region. The TCVs for transmitting control signals and supplying power may be mainly concentrated at, for example, the four corners of the solid-state imaging device 23020, by which a signal wiring area of the first chip 910 can be reduced.

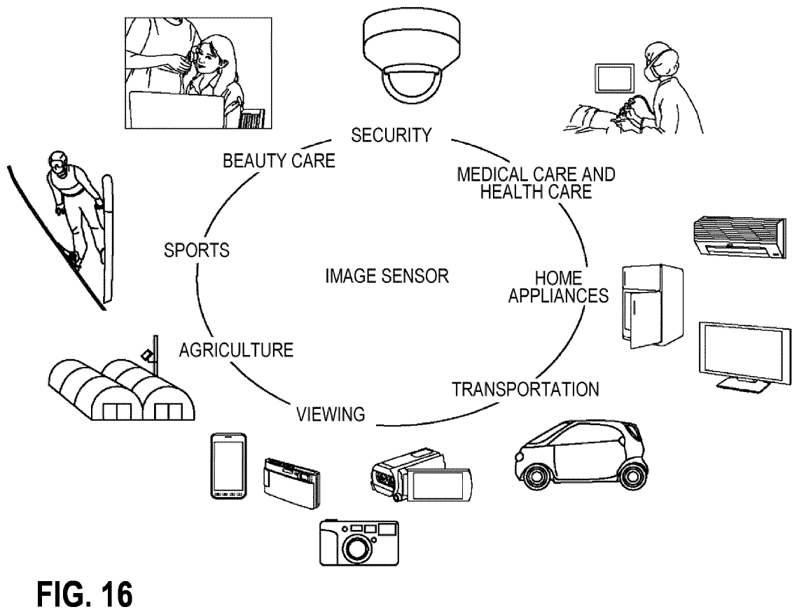

Examples of Application will be described below. The solid-state imaging device according to the examples described above can be used for various devices that sense light such as visible light, infrared light, ultraviolet light, and X-rays, for example, as depicted in FIG. 16. Specific examples of the various devices are listed hereinafter:
i) A device that captures an image for use in viewing, such as a digital camera or a portable device equipped with a camera function.
ii) A device used in transportation, such as a vehicle-mounted sensor that captures images of a front, a rear, surroundings, an interior, and the like of a vehicle, a monitoring camera that monitors traveling vehicles and roads, or a range-finding sensor that measures a distance between vehicles and the like, for safety driving such as automatic stop, recognition of a state of a driver state, and the like
iii) A device used for home appliances such as a TV, a refrigerator, and an air conditioner, to capture an image of a gesture of a user and operate such an appliance in accordance with the gesture.
iv) A device used for medical care and health care, such as an endoscope or a device that performs angiography by receiving infrared light.
v) A device used for security, such as a monitoring camera for a crime prevention application or a camera for a person authentication application.
vi) A device used for beauty care, such as a skin measuring instrument that captures an image of a skin or a microscope that captures an image of a scalp.
vi) A device used for sports, such as an action camera or a wearable camera for sports applications and the like
vii) A device used for agriculture, such as a camera for monitoring states of fields and crops.

The technology according to the present disclosure may be realized in a light receiving device mounted in a mobile body of any type such as automobile, electric vehicle, hybrid electric vehicle, motorcycle, bicycle, personal mobility, airplane, drone, ship, or robot.

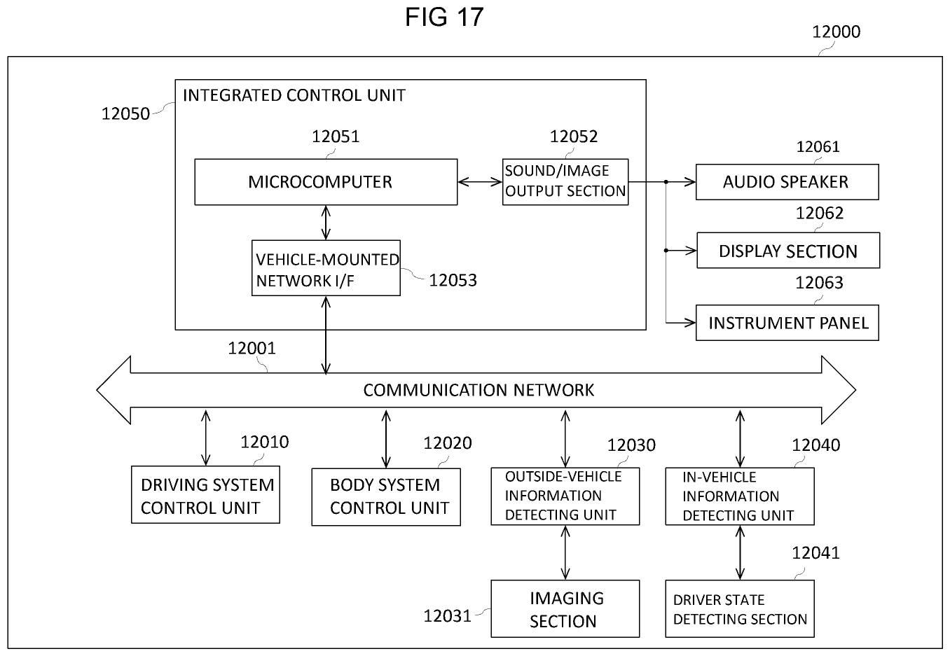

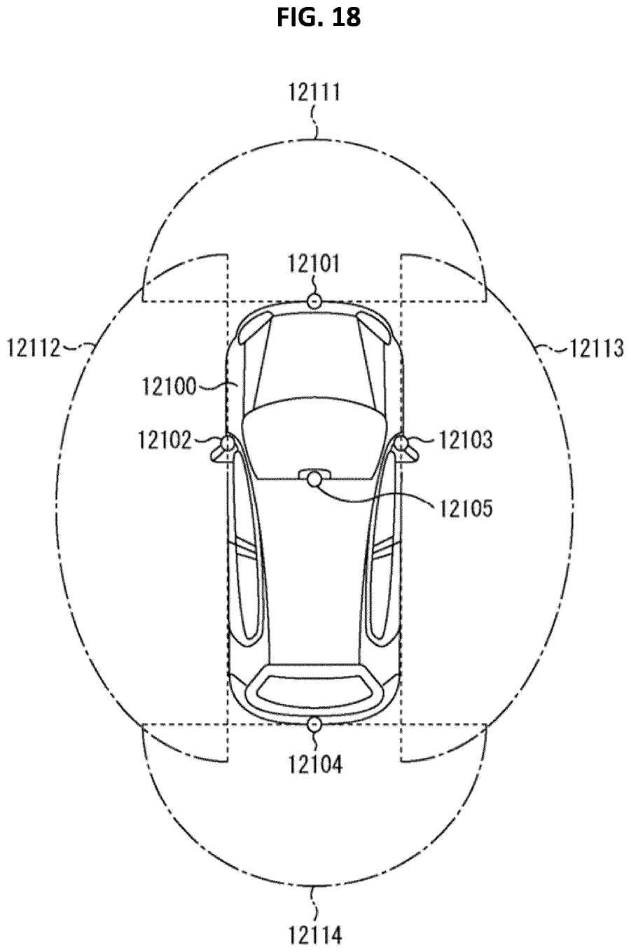

FIG. 17 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 17, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 imaging an image of the outside of the vehicle and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include an image sensor that includes an ADC with a voltage ramp generator according to the embodiments of the present disclosure. The light received by the imaging section 12031 may be visible light or may be invisible light such as infrared rays or the like.

The in-vehicle information detecting unit 12040 detects information about the inside of the vehicle and may be or may include a solid-state imaging device with a raw driver assembly according to the embodiments of the present disclosure. The in-vehicle information detecting unit 12040 is, for example, connected with a driver state detecting section 12041 that detects the state of a driver. The driver state detecting section 12041, for example, includes a camera that includes the solid-state imaging device and that is focused on the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040 and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 17, an audio speaker 12061, a display section 12062, and an instrument panel 12063 are illustrated as the output device. The display section 12062 may, for example, include at least one of an on-board display or a head-up display, wherein each of them may include a solid-state imaging device using a latch comparator circuit for event detection.

FIG. 18 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 18 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, imaging element having pixels for phase difference detection or may include a ToF module including a high dynamic range image sensor that includes an ADC with a voltage ramp generator according to the present disclosure.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control Intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to an embodiment of the present disclosure is applicable has been described above. By applying an image sensor that includes an ADC with a voltage ramp generator according to the present disclosure, the results of image recognition can be more reliable. For example, recognition of pedestrians can be performed on more reliable pixel information. A faulty image sensor can be reliably detected and reported to a higher instance.

Additionally, embodiments of the present technology are not limited to the above-described embodiments, but various changes can be made within the scope of the present technology without departing from the gist of the present technology.

A solid-state imaging device including an image sensor that includes an ADC with a voltage ramp generator circuit according to the present disclosure may be any device used for analyzing and/or processing radiation such as visible light, infrared light, ultraviolet light, and X-rays. For example, the solid-state imaging device may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device may be a device for capturing an image to be provided for appreciation, such as a digital camera, a smart phone, or a mobile phone device having a camera function. In the field of traffic, for example, the solid-state imaging device may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the solid-state imaging device may be integrated in any type of sensor that can be used in devices provided for home appliances such as TV receivers, refrigerators, and air conditioners to capture gestures of users and perform device operations according to the gestures. Accordingly the solid-state imaging device may be integrated in home appliances such as TV receivers, refrigerators, and air conditioners and/or in devices controlling the home appliances. Furthermore, in the field of medical and healthcare, the solid-state imaging device may be integrated in any type of sensor, e.g. a solid-state image device, provided for use in medical and healthcare, such as an endoscope or a device that performs angiography by receiving infrared light.

In the field of security, the solid-state imaging device can be integrated in a device provided for use in security, such as a monitoring camera for crime prevention or a camera for person authentication use. Furthermore, in the field of beauty, the solid-state imaging device can be used in a device provided for use in beauty, such as a skin measuring instrument that captures skin or a microscope that captures a probe. In the field of sports, the solid-state imaging device can be integrated in a device provided for use in sports, such as an action camera or a wearable camera for sport use or the like. Furthermore, in the field of agriculture, the solid-state imaging device can be used in a device provided for use in agriculture, such as a camera for monitoring the condition of fields and crops.

The present technology can also be configured as described below:
[1] A row driver assembly (100), comprising:
   a row driver unit (102) comprising n buffer circuits (104_1), n being an integer larger than 1, wherein each of the n buffer circuits (104_1) includes a high buffer supply input (VDD_1) and a low buffer supply input (VSS_1), and is configured to drive a buffered control signal (CTR_1) to a pixel circuit (106) configured to
   a voltage converter unit (108) electrically coupled to low buffer supply inputs (VSS_1) of the n buffer circuits (104_1), the voltage converter unit (108) including
      a voltage regulator circuit (110_1) comprising an input (I), an output (O), and a reference input (Ref), wherein the output (O) of the voltage regulator circuit (110_1) is electrically coupled to a low buffer supply input (VSS_1) of a first buffer circuit (104_1) of the n buffer circuits (104_1); and
      a charge pump circuit (112_1), wherein an output (Ocp) of the charge pump circuit (112_1) is electrically coupled to the reference input (Ref) of the voltage regulator circuit (110_1).
[2] The row driver assembly (100) according to [1] above, wherein the voltage regulator circuit (110_1) is a low-dropout, LDO, regulator circuit.
[3] The row driver assembly (100) according to [1] or [2] above, wherein the voltage regulator circuit (110_1) is a first voltage regulator circuit (110_1), the row driver assembly (100) further comprising:
   a second voltage regulator circuit (110_2) comprising an input (I), an output (O), and a reference input (Ref), wherein the output (O) of the second voltage regulator circuit (110_2) is electrically coupled to a low buffer supply input (VSS_2) of a second buffer circuit (104_2) of the n buffer circuits (104_1, 104_2), and the output (Ocp) of the charge pump circuit (112_1) is electrically coupled to the reference input (Ref) of the second voltage regulator circuit (110_2).
[4] The row driver assembly (100) according to [1] or [2] above, wherein the voltage regulator circuit (110_1) is a first voltage regulator circuit (110_1), the row driver assembly (100) further comprising:
   a second voltage regulator circuit (110_2) comprising an input (I), an output (O), and a reference input (Ref), wherein the output (O) of the second voltage regulator circuit (110_2) is electrically coupled to a low buffer supply input (VSS_2) of a second buffer circuit (104_2) of the n buffer circuits (104_1, 104_2), and the output (O) of the first voltage regulator circuit (110_1) is electrically coupled to the reference input (Ref) of the second voltage regulator circuit (110_2).
[5] The row driver assembly (100) according to [1] or [2] above, wherein the voltage regulator circuit (110_1) is a first voltage regulator circuit (110_1) and the charge pump circuit (112_1) is a first charge pump circuit (112_1), the row driver assembly (100) further comprising:
   a second charge pump circuit (112_2); and
   a second voltage regulator circuit (110_2) comprising an input (I), an output (O), and a reference input (Ref), wherein the output (O) of the second voltage regulator circuit (110_2) is electrically coupled to a low buffer supply input (VSS_2) of a second buffer circuit (104_2) of the n buffer circuits (104_1, 104_2), and an output (Ocp) of the second charge pump circuit (112_2) is electrically coupled to the reference input (Ref) of the second voltage regulator circuit (110_2).
[6] The row driver assembly (100) according to [5] above, further comprising:
   a third voltage regulator circuit (110_3) comprising an input (I), an output (O), and a reference input (Ref), wherein the output (O) of the third voltage regulator circuit (110_3) is electrically coupled to a low buffer supply input (VSS_3) of a third buffer circuit (104_3) of the n buffer circuits (104_1, 104_2, 104_3), and the output (Ocp) of the first charge pump circuit (112_1) is electrically coupled to the reference input (Ref) of the third voltage regulator circuit (110_3).
[7] The row driver assembly (100) according to [5] above, wherein the voltage regulator circuit (110_1) is a first voltage regulator circuit (110_1), the row driver assembly (100) further comprising:
   a third voltage regulator circuit (110_3) comprising an input (I), an output (O), and a reference input (Ref), wherein the output (O) of the third voltage regulator circuit (110_3) is electrically coupled to a low buffer supply input (VSS_3) of a third buffer circuit (104_3) of the n buffer circuits (104_1, 104_2, 104_3), and the output (O) of the first voltage regulator circuit (110_1) is electrically coupled to the reference input (Ref) of the third voltage regulator circuit (110_3).
[8] The row driver assembly (100) according to [5], wherein the output (Ocp) of the second charge pump circuit (112_1) is electrically coupled to a low buffer supply input (VSS_5) of an n−1-th buffer circuit (104_5) of the n buffer circuits (104_1 . . . 104 6).
[9] The row driver assembly (100) according to any of [1] to [8] above, wherein the output (Ocp) of the charge pump circuit (112_1) is electrically coupled to a low buffer supply input (VSS_n) of an n-th buffer circuit (104_n) of the n buffer circuits (104_1, 104_n).
[10] The row driver assembly (100) according to any of [1] to [9] above, further comprising a control signal switching unit (114) electrically coupled between the row driver unit (102) and the pixel circuit (106).
[11] A solid-state imaging device comprising a chip including the row driver assembly according to any of to [10] above.
[12] The solid-state imaging device according to [11] above, wherein the chip is a circuit chip, and the solid-state imaging device further includes a pixel chip stacked over the circuit chip, the pixel chip including a plurality of pixel circuits arranged in a matrix pattern.
[13] The solid-state imaging device according to [11] or [12] above, further comprising:
   a supply voltage generation unit comprising a plurality of outputs, wherein the supply voltage generation unit is configured to provide supply voltages that differ from one another at the plurality of outputs, wherein the voltage converter unit (108) includes a plurality of voltage regulator circuits (110_1 . . . 110_5), and at least two of the plurality of voltage regulator circuits (110_1 . . . 110_5) include inputs (I) electrically coupled to different outputs of the supply voltage generation unit.
[1] The solid-state imaging device according to [13] above, wherein high buffer supply inputs (VDD_1 . . . VDD_6) of at least two of the n buffer circuits (104_1 . . . 104_6) are electrically coupled to different outputs of the supply voltage generation unit.

1. A row driver assembly, comprising:
a row driver unit comprising n buffer circuits, n being an integer larger than 1, wherein each of the n buffer circuits includes a high buffer supply input and a low buffer supply input, and is configured to drive a buffered control signal to a pixel circuit configured to convert incident radiation into an electric signal;
a voltage converter unit electrically coupled to low buffer supply inputs of the n buffer circuits, the voltage converter unit including a voltage regulator circuit comprising an input, an output, and a reference input, wherein the output of the voltage regulator circuit is electrically coupled to a low buffer supply input of a first buffer circuit of the n buffer circuits; and
a charge pump circuit, wherein an output of the charge pump circuit is electrically coupled to the reference input of the voltage regulator circuit.

2. The row driver assembly according to claim 1, wherein the voltage regulator circuit is a low-dropout, LDO, regulator circuit.

3. The row driver assembly according to claim 1, wherein the voltage regulator circuit is a first voltage regulator circuit, the row driver assembly further comprising:
a second voltage regulator circuit comprising an input, an output, and a reference input, wherein the output of the second voltage regulator circuit is electrically coupled to a low buffer supply input of a second buffer circuit of the n buffer circuits, and the output of the charge pump circuit is electrically coupled to the reference input of the second voltage regulator circuit.

4. The row driver assembly according to claim 1, wherein the voltage regulator circuit is a first voltage regulator circuit, the row driver assembly further comprising:
a second voltage regulator circuit comprising an input, an output, and a reference input, wherein the output of the second voltage regulator circuit is electrically coupled to a low buffer supply input of a second buffer circuit of the n buffer circuits, and the output of the first voltage regulator circuit is electrically coupled to the reference input of the second voltage regulator circuit.

5. The row driver assembly according to claim 1, wherein the voltage regulator circuit is a first voltage regulator circuit and the charge pump circuit is a first charge pump circuit, the row driver assembly further comprising:
a second charge pump circuit; and
a second voltage regulator circuit comprising an input, an output, and a reference input, wherein the output of the second voltage regulator circuit is electrically coupled to a low buffer supply input of a second buffer circuit of the n buffer circuits, and an output of the second charge pump circuit is electrically coupled to the reference input of the second voltage regulator circuit. a third voltage regulator circuit comprising an input, an output, and a reference input, wherein the output of the third voltage regulator circuit is electrically coupled to a low buffer supply input of a third buffer circuit of the n buffer circuits, and the output of the first charge pump circuit is electrically coupled to the reference input of the third voltage regulator circuit.

7. The row driver assembly according to claim 5, wherein the voltage regulator circuit is a first voltage regulator circuit, the row driver assembly further comprising:
a third voltage regulator circuit comprising an input, an output, and a reference input, wherein the output of the third voltage regulator circuit is electrically coupled to a low buffer supply input of a third buffer circuit of the n buffer circuits, and the output of the first voltage regulator circuit is electrically coupled to the reference input of the third voltage regulator circuit.

8. The row driver assembly according to claim 5, wherein the output of the second charge pump circuit is electrically coupled to a low buffer supply input of an n−1-th buffer circuit of the n buffer circuits.

9. The row driver assembly according to claim 1, wherein the output of the charge pump circuit is electrically coupled to a low buffer supply input of an n-th buffer circuit of the n buffer circuits.

10. The row driver assembly according to claim 1, further comprising a control signal switching unit electrically coupled between the row driver unit and the pixel circuit.

11. A solid-state imaging device comprising a chip including the row driver assembly according to claim 1.

12. The solid-state imaging device according to claim 11, wherein the chip is a circuit chip, and the solid-state imaging device further includes a pixel chip stacked over the circuit chip, the pixel chip including a plurality of pixel circuits arranged in a matrix pattern.

13. The solid-state imaging device according to claim 11, further comprising:
a supply voltage generation unit comprising a plurality of outputs, wherein the supply voltage generation unit is configured to provide supply voltages that differ from one another at the plurality of outputs, wherein the voltage converter unit includes a plurality of voltage regulator circuits, and at least two of the plurality of voltage regulator circuits include inputs electrically coupled to different outputs of the supply voltage generation unit.

14. The solid-state imaging device according to claim 13, wherein high buffer supply inputs of at least two of the n buffer circuits are electrically coupled to different outputs of the supply voltage generation unit.
